(19) United States
(12) Patent Application Publication
(10) Pub. No.: US 2025/0040579 A1
(43) Pub. Date: Feb. 6, 2025

(54) VEGAN-BASED EGG WHITE SUBSTITUTE PRODUCT

(71) Applicants: NEGGST FOODS GMBH, Berlin (DE); FRAUNHOFER-GESELLSCHAFT ZUR FÖRDERUNG DER ANGEWANDTEN FORSCHUNG E.V., Munchen (DE)

(72) Inventors: Veronica GARCIA ARTEAGA, Berlin (DE); Katrin HASENKOPF, Freising (DE); Karl Heinz JOHNEN, Aachen (DE); Dietmar OTTE, Berlin (DE); Norbert WEICHELE, Düsseldorf (DE); Jana Frederike CZERWTNSKE, Berlin (DE)

(21) Appl. No.: 18/713,308

(22) PCT Filed: Nov. 24, 2022
(86) PCT No.: PCT/EP2022/083152

§ 371 Date: May 24, 2024

(30) Foreign Application Priority Data
Nov. 25, 2021 (DE) 10 2021 130 963.8
Nov. 25, 2021 (DE) 10 2021 130 974.3
Nov. 25, 2021 (DE) 10 2021 130 977.8

(51) Int. Cl. A23L 15/00; A23J 3/14; A23J 3/22; A23L 29/256; A23L 29/262

(52) U.S. Cl. CPC A23L 15/35; A23J 3/14; A23J 3/225; A23L 29/256; A23L 29/262

(57) ABSTRACT

A vegan-based egg white substitute product containing (a) drinking water, (b) one or more protein(s) from legumes, oil seeds, grains, microorganisms, and/or algae, (c) a combination of one or more thermogelling hydrocolloid(s) with one or more reversibly gelling hydrocolloid(s), and (d) one or more salt(s), wherein the proportion of the combination of one or more reversibly thermogelling hydrocolloid(s) and one or more reversibly gelling hydrocolloid(s) ranges from 0.25-5.00 wt. %. The invention additionally relates to a method for producing the egg white substitute product and to the use of the egg white substitute product in the production of or as a component of an emulsion or a liquid consisting of at least one phase or as an ingredient in a meal or a baked product or a simulated egg.

### FIELD OF THE INVENTION

The invention relates to a vegan-based egg white substitute product.

### BACKGROUND OF THE INVENTION

The awareness of the importance of a sustainable lifestyle also means that the importance of a purely plant-based diet is continuously increasing. In addition to pure vegans and vegetarians, more and more people are trying to reduce the consumption of animal products (flexitarians and flexigans). The latter means that more and more plant-based foods are in demand and are also available, which offer consumers a similar taste experience to the corresponding animal products.

Eggs are a high-quality source of protein and, in addition to being consumed directly, they fulfill many tasks in food, such as the formation of emulsions and foams and the stabilization of dough masses. Due to the wide range of possible uses, a vegan alternative for eggs that covers as many areas as possible is a major challenge.

Chicken egg white accounts for 55-60% of the total egg weight. In addition to 80-84% water, egg white also contains 12% protein, 0.7% carbohydrates, 0.7% minerals and 0.03% lipids. Depending on the freshness of the product, egg white has a pH of 7.6 to 9.7; pH increases during storage due to CO2 diffusion through the eggshell. The albumen contains different proteins: ovalbumin (54%), conalbumin (12%), ovomucoid (11%) and ovomucin (3.5%).

Due to its protein content and high-quality amino acid composition, egg white of animal origin is an important source of protein. It has all the amino acids essential for humans and therefore has a high protein value.

Chicken egg white has an apparent viscosity of about 0.350 Pa s and shows a slightly shear thinning (pseudoplastic) behavior. The mechanism of thermally induced gelation of egg-containing systems involves the unfolding of native proteins in solution in a first step, followed by protein-protein interactions that form a 3D network. Gel formation depends on protein concentration, ionic strength, pH, and interactions with other components. The denaturation temperature of egg white is between 61° C. and 93° C. Sugar and salt increase the denaturation temperature of egg proteins and delay the formation of aggregates. The gelation/coagulation factors also affect the texture of the cooked egg. The cooked egg white has a hardness of 17N, which can be reduced by adding salt. At pH 5-6, the albumen gel has a coarse, aggregated structure, whereas protein strands and globules are arranged in a uniform matrix at pH 9.

In addition to its high nutritional value, egg white also performs many technological roles in food: Egg whites can be whipped into very stable foams and used to fluff baked goods and other foods. It supports binding in a wide variety of preparations and, thanks to its coagulability, hardens baked goods when heated.

There are already various egg white substitute products which, based on various starches and hydrocolloids, can be used as dry or liquid products in foods and can largely or partially take over the tasks of egg white (US 2013/0084361 A1).

WO 2017/014967 A1 and WO 2017/014806 A1 relate to plant-based egg substitute compositions which are characterized by a high content of hydrocolloids.

WO 2019/220431 A1 also relates to egg replacement compositions that have more than 5% hydrocolloids.

WO 89/10704 relates to an egg substitute in which the yolk substitute is surrounded by a membrane and combined with a natural egg white or a treated egg white or egg white analogue.

### OBJECT OF THE INVENTION

The object of the present invention is to provide a white to colorless foodstuff which is similar to chicken egg white and which is partially transparent, which forms a gel structure when heated and which is largely retained after cooling. The liquid egg white substitute product should be processed in a similar way to liquid chicken Albumen, i.e. to enable the introduction of gases by means of mechanical energy, as well as to provide a gas holding capacity comparable to liquid egg white, then solidify when heated and loosen baked goods and other foods, for example.

### BRIEF SUMMARY OF THE INVENTION

The object is achieved by a vegan-based egg white substitute including
(a) drinking water
(b) one or more protein(s) from legumes, oilseeds, cereals, microorganisms and/or algae,
(c) a combination of one or more thermogelling hydrocolloid(s) with one or more reversibly gelling hydrocolloid(s),
(d) one or more salt(s),
wherein a proportion of the combination of the one or more reversibly thermogelling hydrocolloid(s) with the one or more reversibly gelling hydrocolloid(s) is 0.25-5.00% by weight.

The percentages given in the text below are in each case % by weight. The terms “egg white” and “protein” are used interchangeably.

“Vegan-based” means that it contains no animal or animal-derived ingredients.

Vegetable raw materials from the group of legumes, cereals, oilseeds, microorganisms and (micro)algae, advantageously vegetable proteins from peas (Pisum sativum), chickpeas (Cicer arientinum), garden beans (Phaseolus vulgaris), Faba beans (also known as field beans; Vicia faba), sweet lupins (Lupinus), lentils (Lens culinaris), corn (Zea mays), hemp (Cannabis sativa), sweet potatoes (lpomoea batatas), cassava (Manihot esculenta), potatoes (Solanum tuberosum), pumpkin (Cucurbita), flax (Linum usitatissimum), oilseed rape (Brassica napus), soy (Glycine max), oats (Avena sativa), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori alga and/or wakame alga are suitable as a protein source, particularly advantageous are proteins from peas, chickpeas, fab bean, lupine, hemp, pumpkin and mung bean. As a protein source (raw and/or hydrolyzed and/or fermented) flours, protein concentrates, protein isolates and/or any combination thereof obtained from the plants and plant parts per se, their seeds, tubers and/or their fruits of the aforementioned raw materials can be used. The person skilled in the field of food technology is sufficiently familiar with the processing and nutritional suitability of the plants and respective plant parts.

According to the invention, a transparent white product is provided which is made from the above proteins from one or more vegetable protein sources. The solubility of proteins is higher in salt solutions than in pure water. Therefore, to solubilize the proteins, a saline solution from drinking water and an edible inorganic salt, advantageously a sodium chloride (NaCl) solution, is prepared and the protein source is dispersed therein. In principle, however, other salts are also suitable, such as sodium dihydrogen phosphate (NaH₂PO₄), disodium hydrogen phosphate (Na₂HPO₄), trisodium phosphate (Na₃PO₄), sodium pyrophosphate (Na₄P₂O₇) and also potassium chloride (KCl). It is of course also possible to disperse the protein source and the salt in drinking water at the same time. In some embodiments, the salt concentration, advantageously NaCl concentration, is greater than 0.05%, advantageously greater than 0.10%, greater than 0.15%, greater than 0.20%, greater than 0.30%, greater than 0.40% or greater than 0.50%. In some embodiments, the salt concentration, advantageously NaCl concentration, is 0.05%-0.80%, advantageously 0.10%-0.70%, 0.20%-0.60% or 0.4%-0.6%.

Either kala Namak (black salt) or other salts and/or natural flavors that contain sulfur compounds can be used to create an egg-like flavor. The Sulphur-containing compounds, in particular the Kala Namak salt, can be used together with the salt of the brine, advantageously NaCl, to obtain the same concentrations. However, it can also be used in smaller, larger, or equal amounts.

The amount of dissolved proteins is advantageously more than 0.1%. In some embodiments, the amount of dissolved proteins is more than 1.0%, advantageously more than 2.5%, more than 4.0%, more than 5.0%, more than 8.0%, more than 10.0% % or more than 12%. In some embodiments, the amount of dissolved proteins is 0.5%-15.0%, advantageously. 1.0%-12.0%, 1.5%-10.0% or 2.0%-5.0% in the egg white substitute product according to the invention.

The egg white substitute contains hydrocolloids to set the desired viscosity and solidify when heated. A combination of one or more thermogelling hydrocolloids with one or more reversibly gelling hydrocolloids has proven to be advantageous, with the two types differing in their behavior with temperature changes. The hydrocolloids, which gel quickly when the temperature is increased to >40° C., are called “thermogelling” or “thermo-reversible gelling” and are advantageously modified celluloses, advantageously methyl celluloses, hydroxyethyl celluloses, hydroxypropyl methyl celluloses (HPMC) and/or hydroxypropyl celluloses. However, the resulting gelation is only temporary: when it cools down to <40°, the gel changes back into the original viscous solution. To produce the thermogelation, a specific minimum concentration of the thermogelling hydrocolloids should be present, which is about 1.5 g/l for methylcellulose. The person skilled in the art can determine the minimum concentration for other thermogelling hydrocolloids without great experimental effort. Below this concentration, no gelation occurs when the aqueous solution is heated. Reversibly gelling hydrocolloids form gels at room temperature (approx. 20° C.) which—in contrast to thermogelling hydrocolloids—melt when heated within a certain temperature interval, i.e. liquefy, and form a viscous solution which, in turn, after cooling to or below the gelling temperature gelled again. The reversibly gelling hydrocolloids used are those from algae, advantageously carrageenan and/or agar. Other hydrocolloids, advantageously gellan gum, locust bean gum, guar gum, alginate and/or xanthan gum, are also used to set the desired consistency and support the permanent solidification of the vegan egg white. According to the invention, the amount of hydrocolloids in the albumen is less than 5.00% (e.g. less than 4.75%, 4.50%, 4.25%, 4.00%, 3.75%, 3.50%, 3, 25%, 3.00%, 2.75%, 2.50%, 2.25%, 2.00%, 1.75%, 1.50%, 1.00%, 0.75% or equal or less than 0.50%). In some embodiments, the amount of hydrocolloids in the egg yolk replacer is 0.10%4.5%, (e.g. 0.20%-4.00%, 0.25%-3.00%, 0.50%-2.50% or 0.75%-2.00%). The split between thermogelling and reversibly gelling hydrocolloids is advantageously 50:50, advantageously 25:75, 30:70 or 40:60 or 75:25, 70:30 or 60:40. A level of hydrocolloids less than 5.00% allows the provision of a liquid raw egg substitute, but on the other hand provides stability and texture comparable to a chicken egg, when cooking.

In some embodiments, transglutaminases can be optionally added in order to improve the texture of the protein solutions or emulsions. The effect of transglutaminases on texture lies in their ability to promote cross-linking of proteins under certain temperature and time conditions. The amount of transglutaminases is advantageously between 0.001% and 3.00%, more advantageously 0.01%-1.5%, more advantageously 0.1%-1.0%, The transglutaminases are activated while the protein solution or emulsion is heated to temperatures between 40° C.˜60° C. for at least 15 minutes, advantageously 30 minutes, 60 minutes, 90 minutes, or 120 minutes. The transglutaminase can, but need not, be microencapsulated and can advantageously be inactivated during manufacture of the egg replacer by pasteurization or UHT treatment (above 75° C. or 120° C. respectively).

In some embodiments, vegetable oils can optionally be added to the mixture. The amount is advantageously between 0.1% and 4%, advantageously between 0.5 and 2.0%, Vegetable oils are suitable, e.g. olive oil, coconut oil, linseed oil, walnut oil, safflower oil or peanut oil; however, tasteless fats such as rapeseed oil, sunflower oil, coconut fat and/or corn oil and any combination thereof are advantageous.

In order to produce a browning of the product when heated, for example when frying a “fried egg”, which is caused by a so-called Maillard reaction, a small amount of sugar is advantageously added to the product. The sugars are advantageously monosaccharides (e.g. dextrose, fructose, and/or galactose) and/or disaccharides (e.g. lactose and/or maltose). In some embodiments, the amount of sugar in the egg white is less than 1.00%, advantageously less than 0.75%, less than 0.50%, less than 0.25%, or less than 0.10%. In some embodiments, the amount of sugar in the egg white is 0.10%-1.00%, advantageously 0.25%-0.75%, 0.50%-0.50% or 0.75%-0.25%, The egg white substitute can also contain small amounts (less than 10.0%, advantageously less than 5%, 3% or 2%) of additional minor components. These can be emulsifiers, aroma formulations (especially those containing sulfur compounds), spices, natural colorings, preservatives, thickeners, or health-promoting additives. Examples are iodine, vitamins (e.g. vitamin B₁, B₂, B₃, B₅, B₇, B₉, B₁₂, D₃ or E), minerals (e.g. Ca or Mg) and/or plant lecithin (also acts as an emulsifier).

The egg white substitute contains essentially no carotenoids or no carotenoids at all.

The protein source(s) and the salt are dispersed in drinking water. The pH is adjusted to between 6 and 9, advantageously higher than 8.0, most advantageously around 8.5, with pH food regulators such as sodium hydroxide (NaOH), potassium phosphate (K₃PO₄) or sodium citrate (Na₃C₆H₅O₇). The solution is advantageously stirred for at least 1 minute, more advantageously 5-10 minutes, more advantageously 15 minutes to enhance swelling of the proteins. It is advantageous, but not necessary, after swelling, to separate the proteins by suitable separation methods, advantageously centrifugation, decantation, or membrane filtration. This separation results in a supernatant containing the soluble proteins and a pellet containing the insoluble proteins. Depending on the salt concentration in the solutions used, the soluble proteins are mainly globulins and albumins. The supernatant solution (solution (A)) is further used for egg white production, while the residue or pellet can be used for the production of other products, e.g. a vegan egg yolk substitute.

According to the invention, the protein source is dispersed in water or an aqueous salt solution (solution (A)). Solution (A) can be divided into two parts ((A1) and (A2)). However, it is also possible to prepare two solutions (A1) and (A2) independently of one another: (A1) can be an aqueous protein or protein-salt solution and (A2) that of another protein or just water. Optionally, 0.001%-2.00% transglutaminase can be added to solution (A1). If unencapsulated transglutaminase is used, the solution should be kept at 50° C. for less than 120 minutes. Solution (B) is prepared by heating solution (A1) to at least 40° C., advantageously 50° C. but not more than 60° C., and adding one or more thermogelling hydrocolloids (e.g. modified cellulose, methyl cellulose and/or hydroxypropyl cellulose) manufactured. The effect of heat improves the dispersion of the hydrocolloids. Before or after dispersion of the hydrocolloids, oil (possibly containing 0.01%-50% emulsifiers), if necessary a source of calcium ions, natural dyes and if necessary other additives are mixed in solution (B). Solution (C) is prepared by mixing solution (A2) with one or more reversibly gelling hydrocolloids at a temperature below 30° C., advantageously less than 20° C., 15° C. or 10° C. Additionally natural flavors, aroma formulations, oil and (encapsulated) transglutaminase or other additives can be mixed in solution (C). Once all components of solutions (B) and (C) are fully dispersed, solutions (B) and (C) are mixed at a temperature advantageously below 30° C., resulting in the final egg white solution (solution (D)). The solutions and dispersions described above are prepared in standard mixing vessels using known dispersion techniques.

The preparation of the solutions is advantageously performed under vacuum, but this is not essential. The vacuum can prevent air bubbles from forming in the egg white substitute. Surprisingly, the degree of transparency increases when the vacuum is reduced to an absolute pressure of less than 800 mbar, better less than 500 mbar, advantageously less than 300 mbar, particularly advantageously less than 100 mbar or 50 mbar.

In order to simulate the consistency of chicken egg white, the mucilage from hydration or cooking of seeds such as flaxseed or chia seeds can advantageously be used. Hydration can be in water or in a soluble protein solution, The solution (A) and/or the obtained egg white substitute product according to the invention can be pasteurized. Thermal or non-thermal processes such as pasteurization, ultra-high pasteurization (UHT), high-pressure pasteurization (HPP) or “Pulsed Electric Field” technology (PEF) can be used for this. Both thermal and non-thermal stabilization processes are sufficiently well known to those skilled in the art to achieve a shelf life of at least 3 weeks below 8 degrees Celsius (storage temperature). The albumen may have an initial viscosity, defined as resistance to deformation at a given speed, ranging between 0,005 Pas and 20.0 Pas, advantageously 0.1 Pas-19 Pas, 1.0 Pas-15 Pas or 5.0 Pas-10.0 Pas. The viscosity can be measured using a rheometer (MCR301 SN802801740, Anton Paar GmbH, Graz, Austria) with a cylindrical measuring system (CC27-SN 12031) with a measuring gap d=1.136 mm. A person skilled in the art knows how to carry out the viscosity measurement using a rheometer. Only exemplary conditions are described below. The cylinder is filled with e.g. 15 ml of the sample. The sample is equilibrated for 5 minutes at 10° C. and left for the measurement. The rotation is increased linearly from 2-100 s⁻¹ within 60 s. The rotation of 100 s⁻¹ is maintained for 30 s before declining from 100˜2 s⁻¹ over 60 s. The viscosity is adjusted for a given type and concentration of protein by adding hydrocolloids, salt and buffer salts and is carried out experimentally by measuring the viscosities.

The cooked egg white may have a hard texture, the hardness [N] being characterized by a breaking strength ranging between 2N and 50N, advantageously 5N-30N, 10N-25N or 15N-20N. The breaking force can be determined, for example, using a texture analyzer with evaluation software from Stable Micro Systems (Godalming, UK). Exemplary conditions are: deformation of 50%, 5 kg load, cylindrical punch with a diameter of 40 mm, and a supernatant speed of 10 mm/min.

When using commercially available vegetable proteins, the color of the cooked egg white (cooked, stirred, fried) depends on the protein concentration. The higher the protein content, the whiter the color of the albumen (see FIG. 5). The cooked egg white color can range from transparent to white in the L*a*b* color space. The brightness (L*) can range from 70-99, better from 80-96; the red-green (a*) can range from −10-5, better from −5-3; the yellow-blue (b*) can be 8-35, better 11-28, even better 15-25. The color can be fine-tuned using natural dyes.

Surprisingly, such an egg white substitute product can be mixed largely homogeneously with an animal (natural) egg yolk or an egg yolk substitute product in a ratio of about 2:1 to form a “scrambled egg” and a consistency similar to scrambled eggs is formed. Surprisingly, if these two phases are not mixed, when frying in a pan, a product can be prepared that corresponds in appearance and consistency to a fried egg (FIG. 6).

Other foods can also be produced with the protein according to the invention and/or the “whole egg” mixture. Examples are sponge cakes, quiche, pancakes, or similar foods. These foods, which contain a mixture of the egg white substitute product according to the invention with natural egg yolk or egg yolk substitute product, are indistinguishable or only slightly different from a recipe containing chicken eggs in terms of color, taste, and texture.

A particularly advantageous embodiment of the present invention includes:

| Component | Amount (weight %) | Range (weight %) |
|---|---|---|
| NaCl | 0.375 | 0.2-0.5 |
| Protein source (e.g. faba | 8.000 | 0.05-15.0 |
| bean protein or pea protein | | |
| Source for calcium ions | 0.000 | 0.0-1.25 |
| Citric acid salts | 0.000 | 0.0-1.25 |
| Sun flower oil/rapeseed oil | 0.000 | 0.0-2.0 |
| Methyl cellulose | 1.500 | 0.1-2.5 |
| Carrageen | 1.250 | 0.1-2.5 |
| Xanthan | 0.000 | 0.0-2.5 |
| Potassium chloride | 0.030 | 0.0-1.5 |
| Dextrose | 0.025 | 0.0-1.5 |
| Natural Aromatics | 0.000 | 0.0-1.5 |
| Vitamin D3 | 0.000001 | 0.0-0005 |
| Water | 78.205 | Rest (68-99.1) |

The invention is described in more detail with reference to drawing figures, wherein:

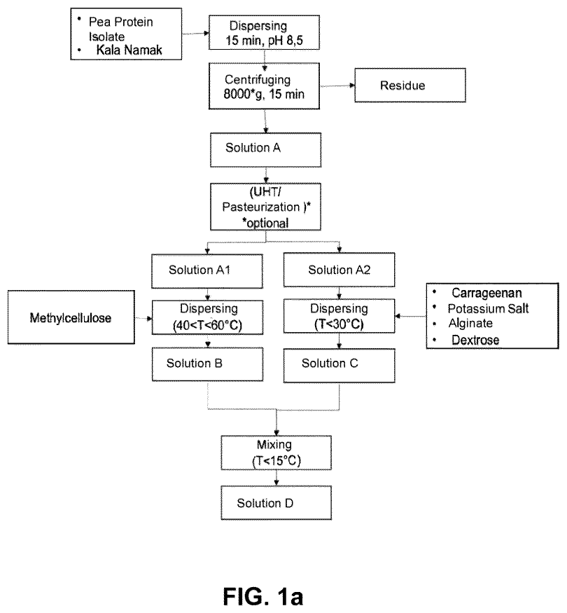

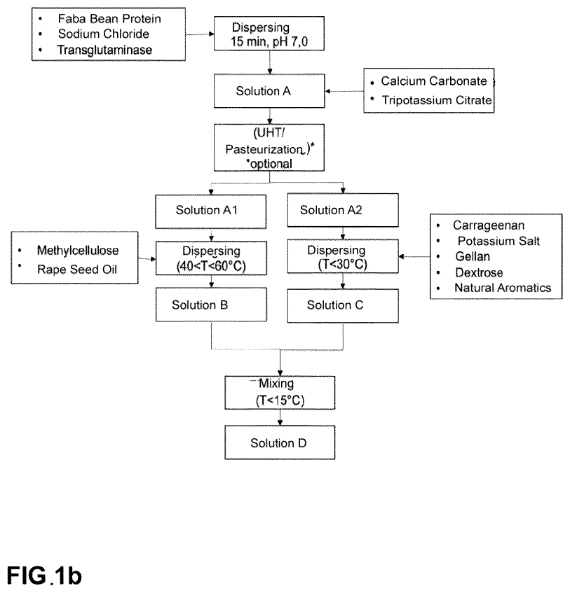

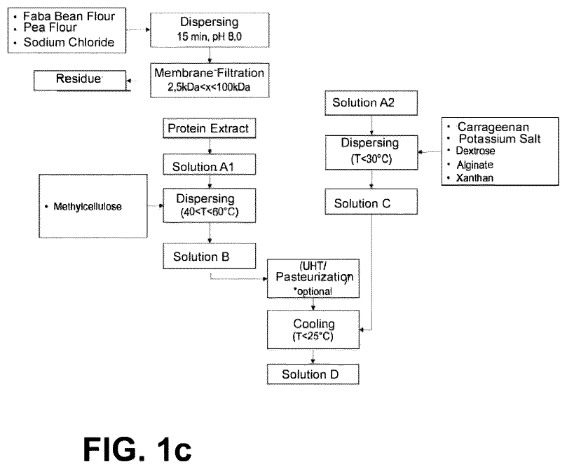

FIG. 1a: shows a diagram for the production of an egg white substitute product according to embodiment 1;

FIG. 1b: shows a diagram for the production of an egg white substitute product according to embodiment 2;

FIG. 1c: shows a diagram for the production of an egg white substitute product according to embodiment 3;

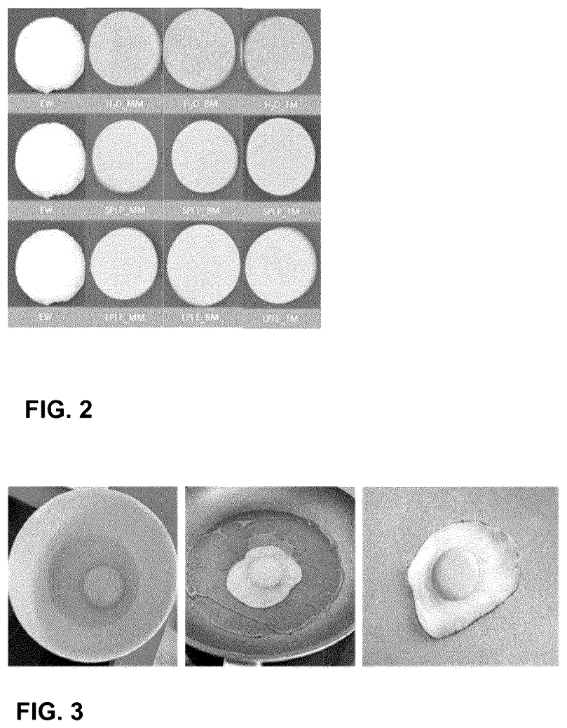

FIG. 2; shows albumen color; and
EW: egg white from chicken egg
H2O: water
SPI: Soy Protein Isolate
LPI: Lupine Protein Isolate
MM: Hypromellose
BM: Hydroxypropyl methylcellulose TM: methyl cellulose

FIG. 3: shows production of a fried egg

In the following, egg white substitute products according to the invention are described. However, this is to be understood as an example and does not represent a restriction to exactly these embodiments.

### EMBODIMENTS

### Embodiment 1

Water 81.10%
Pea protein isolate 15.00%
Methyl cellulose 1.50%
Carrageenan 1.50%
Alginate 0.25%
Dextrose 0.25%
Potassium Chloride 0.15%
Kala Namak 0.25%
Production is performed according to FIG. 1a.

### Embodiment 2

Water 83.07%
Faba bean protein isolate 10.00%
Sodium Chloride 0.08%
Transglutaminase 0.90%
Calcium carbonate 0.75%
Tri potassium Citrate 0.95%
Methyl cellulose 1.50%
Rapeseed oil 0.25%
Carrageenan 0.85%
Gellan 0.35%
Dextrose 0.25%
Potassium Chloride 0.20%
Natural Flavor 0.85%
Production is performed according to FIG. 1b.

### Embodiment 3

Water 73.62%
Faba bean flour 8.00%
Pea flour 15.00%
Sodium Chloride 0.08%
Methyl cellulose 1.50%
Carrageenan 0.85%
Alginate 0.35%
Xanthan Gum 0.15%
Dextrose 0.25%
Potassium Chloride 0.20%
Production is performed according to FIG. 1c.

1. A vegan based egg white substitute product, comprising:
(a) drinking water;
(b) one or more protein(s) from legumes, oilseeds, cereals, microorganisms and/or algae;
(c) a combination of one or more thermogelling hydrocolloid(s) with one or more reversibly gelling hydrocolloid(s);
(d) one or more salt(s),
wherein a portion of the combination of the one or more reversibly thermogelling hydrocolloid(s) with the one or more reversibly gelling hydrocolloid(s) is 0.25-5.00% by weight.

2) The egg white substitute product according to claim 1, the mix further comprising: a substance including sulfur compounds.

3) The egg white substitute product according to claim 2, wherein the substance including the sulfur compounds includes a flavoring formulation and/or kala Namak (black salt).

4) The egg white substitute product according to one of the claims 1 to 3, wherein the thermogelling hydrocolloid is methyl cellulose.

5) The egg white substitute product according to one of the claims 1 to 4, wherein the reversibly gelling hydrocolloid is carrageenan.

6) The egg white substitute product according to one of the claims 1-5, wherein the plant protein comes from peas, chickpeas, mung beans, hemp, pumpkin and/or field beans.

7) The egg white substitute product according to one of the claims 1-6, wherein the plant protein is provided in a form of a raw and/or hydrolyzed and/or fermented flour, as a protein concentrate, as a protein isolate and/or any combination thereof.

8) The egg white substitute product according to one of the claims 1-7, wherein an amount of dissolved proteins is 0.1% by weight 15.0% by weight.

9) The egg white substitute product according to one of the claims 1-8, wherein a salt concentration is 0.025% by weight-0.80% by weight.

10) The egg white substitute according to one of the claims 1-9, wherein an amount of hydrocolloids is 0.5%-3.5% by weight.

11) The egg white substitute product according to one of the claims 1-10, the mix further comprising: sugar in an amount of 0.10% by weight-1.00% by weight.

12) The egg white substitute product according to one of the claims 1-11, further comprising: a vegetable oil, advantageously in an amount of 0.1-4.0% by weight.

13) A method for producing the egg white substitute product according to one of the claims 1-12, the method comprising:
(a) dispersing one or more plant proteins and salt in drinking water;
(b) adjusting a pH of a solution from step (a) to pH 6-9 and optionally allowing it to swell for 1-15 minutes;
(c) optionally separating soluble supernatant from insoluble residue;
(d) separating the solution from step (b) or the soluble supernatant from step (c) into a first and a second part;
(e) preparing a solution by heating the first part of step (d) to at east 40° C. and adding one or more thermogelling hydrocolloid(s);
(f) preparing a solution by adding one or more reversibly gelling hydrocolloid(s) to the second part of step (d) at room temperature or at a temperature up to 30° C.;
(g) mixing the solutions obtained in steps (e) and (f) at room temperature or at temperatures up to 60° C. to obtain the egg white substitute product.

14) A method for producing the egg white substitute product according to one of claims 1-12, the method comprising:
(a) dispersing of one or more plant proteins and salt in drinking water;
(b) adjusting a pH of a solution from step (a) to pH 6-9 and optionally allowing it to swell for 1-15 minutes;
(c) optionally separating soluble supernatant from insoluble residue;
(d) adding one or more reversibly gelling hydrocolloid(s) to the solution from step (b) or the supernatant from step (c) and heating to a maximum of 30° C. with stirring; and
(e) adding one or more thermogelling hydrocolloid(s) under stirring until fully dispersed to obtain the egg white substitute product.

15) The method according to claim 13 or 14, wherein the supernatant from step (c) and/or the obtained egg white substitute product is pasteurized.

16) The method according to claim 15, wherein the supernatant from step (c) and/or the obtained egg white substitute product is preserved by non-thermal methods.

17) The method according to claim 16, wherein the thermal (pasteurization, UHT) and/or non-thermal process is high-pressure pasteurization (HPP) or “Pulsed Electric Field” technology (PEF).

18) The method according to one of claims 13-18, wherein the thermogelling hydrocolloid is added at a temperature of about 50° C.

19) An egg white substitute product producible by the method according to one of claims 13-18 and, after heating, characterized by a viscosity of between 0.005 Pa's and 20.0 Pa's.

20) A use of an egg white substitute product according to one of claims 1-12 for producing or as a component of an emulsion or a liquid including at least one phase, as an ingredient for a food product, or a baked product, or a whole egg substitute product.

21) The use according to claim 20, wherein a vegan emulsion or vegan liquid, vegan food product or vegan baked product or a vegan whole egg substitute product is produced.

22) The use according to claim 20, wherein a non-vegan emulsion or a non-vegan liquid, non-vegan food product or non-vegan baked product or a non-vegan whole egg substitute product is produced.

23) A method for producing an emulsion, liquid, food, baked good or a whole egg substitute product, wherein the egg white substitute product according to one of claims 1-12 is used as an ingredient in the emulsion, liquid, baked product, food product or the whole egg substitute product.
